(19) United States
(12) Patent Application Publication
(10) Pub. No.: US 2014/0332655 A1
(43) Pub. Date: Nov. 13, 2014

(54) Fishing Gear Holding Apparatus

(71) Applicant: Jeff Colbert, Fort Payne, AL (US)

(72) Inventor: Jeff Colbert, Fort Payne, AL (US)

(73) Assignee: Reel Deal, LLC, Fort Payne, AL (US)

(21) Appl. No.: 14/057,037

(22) Filed: Oct. 18, 2013

Related U.S. Application Data
(60) Provisional application No. 61/820,965, filed on May 8, 2013.

(51) Int. Cl. A01K 97/10; B60R 9/06

(52) U.S. Cl. CPC A01K 97/10; B60R 9/06
USPC 248/512; 211/70.8; 224/519

(57) ABSTRACT

An apparatus of the present disclosure has a frame, which has a receiving shelf and horizontal support beam respectively coupled to opposing ends of a vertical center beam and at least one leg coupled to the frame adapted such that when the leg is actuated, the frame stands upright and a fishing rod may be supported by the receiving shelf and the horizontal support beam. The apparatus further has a hitch coupled to the frame arranged and positioned such that when the at least one leg is not actuated, the frame may be coupled to a vehicle.

### CROSS-REFERENCE TO RELATED APPLICATION

This application claims priority to U.S. Patent Application No. 61/820,965 entitled Fishing Gear Holding Apparatuses and Methods filed May 8, 2013, which is incorporated herein by reference in its entirety.

### BACKGROUND

Fishing rods are large objects that can be difficult to store and transport. In particular, it is quite easy for the lines and hooks of said rods to become tangled and tied together. Furthermore, most modern motor vehicles are not manufactured with enough space to allow for easy loading and unloading of fishing rods when transporting from a home to a body of water for sport.

It is also often desirable to have the ability to access multiple rods when fishing alongside a body of water. When working with families and large groups, a fisherman may be required to maintain multiple lines with proper lures and supporting gear. Many fishermen also like to monitor multiple styles of rods/lures in the hopes of attracting different or more desirable fish.

### SUMMARY

An apparatus of the present disclosure has a frame, which has a receiving shelf and horizontal support beam respectively coupled to opposing ends of a vertical center beam and at least one leg coupled to the frame adapted such that when the leg is actuated, the frame stands upright and a fishing rod may be supported by the receiving shelf and the horizontal support beam. The apparatus further has a hitch coupled to the frame arranged and positioned such that when the at least one leg is not actuated, the frame may be coupled to a vehicle.

### BRIEF DESCRIPTION OF THE DRAWINGS

The various embodiments of the present disclosure and their advantages are best understood by referring to FIGS. 1 through 10 of the drawings. The elements of the drawings are not necessarily to scale, emphasis instead being placed upon clearly illustrating the principles of the disclosure. Throughout the drawings, like numerals are used for like and corresponding parts of the various drawings.

FIG. 1 is a photograph of a front-side perspective view of a fishing gear holding apparatus in accordance with an embodiment of the present disclosure.

FIG. 2 is a photograph of a top perspective view of a fishing gear holding apparatus such as is depicted in FIG. 1.

FIG. 3 is a photograph of a top perspective view of a shelf of the fishing gear holding apparatus such as is depicted in FIG. 1.

FIG. 4 is a photograph of a hitch of the fishing gear holding apparatus such as is depicted in FIG. 1.

FIG. 5 is a photograph of a lower side perspective view of a fishing gear holding apparatus such as is depicted in FIG. 1 with the hitch as depicted in FIG. 4 removed.

FIG. 6 is a photograph of a lower side perspective view of a fishing gear holding apparatus such as is depicted in FIG. 1 with the hitch as depicted in FIG. 4 coupled to the apparatus.

FIG. 7 is a photograph of a front-side perspective view of a fishing gear holding apparatus such as is depicted in FIG. 1 ready for use as a fishing rod holder with fishing rods inserted.

FIG. 8 is a photograph of a top perspective view of a fishing gear holding apparatus such as is depicted in FIG. 1 ready for use as a fishing rod holder with fishing rods inserted.

FIG. 9 is a photograph of a front-side perspective view of a fishing gear holding apparatus such as is depicted in FIG. 1 attached to a vehicle for transportation.

FIG. 10 is a photograph of a front perspective view of a fishing gear holding apparatus such as is depicted in FIG. 1 attached to a vehicle for transportation with fishing rods loaded and secured.

### DETAILED DESCRIPTION

Furthermore, reference in the specification to “an embodiment,” “one embodiment,” “various embodiments,” or any variant thereof means that a particular feature or aspect of the disclosure described in conjunction with the particular embodiment is included in at least one embodiment of the present disclosure. Thus, the appearance of the phrases “in one embodiment,” “in another embodiment,” or variations thereof in various places throughout the specification are not necessarily all referring to its respective embodiment.

This disclosure may be provided in other specific forms and embodiments without departing from the essential characteristics as described herein. The embodiments described above are to be considered in all aspects as illustrative only and not restrictive in any manner.

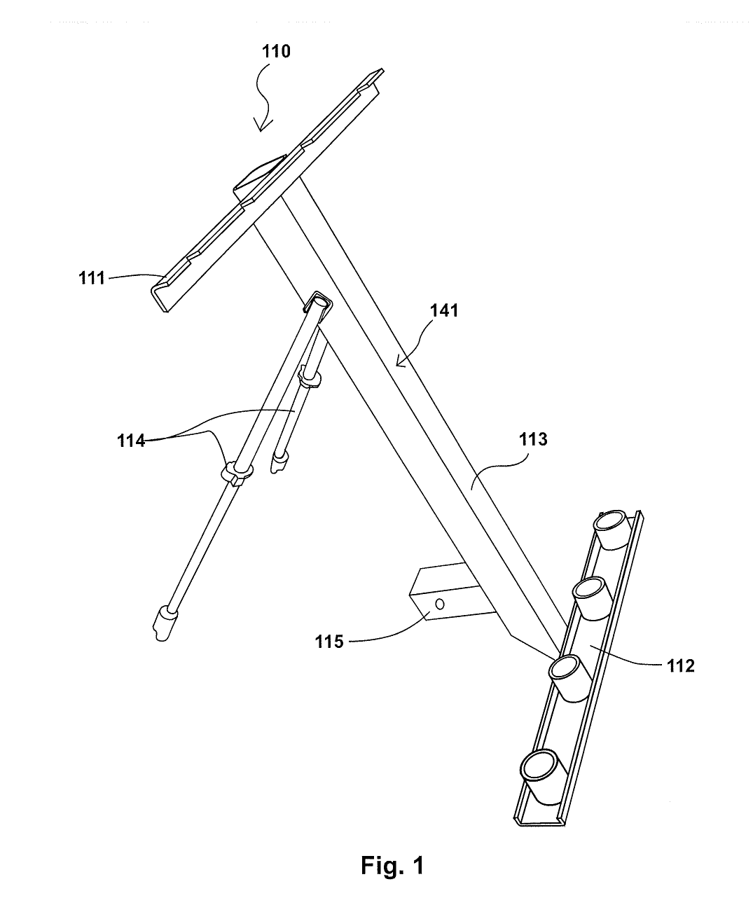

FIG. 1 depicts an exemplary embodiment of the fishing gear holding apparatus 110. The fishing gear apparatus 110 comprises a substantially “I” shaped frame 141 comprising a horizontal support beam 111, a horizontal receiving shelf 112, and a vertical center bar 113. In this regard, the vertical center bar 113 is coupled on a first end to the horizontal receiving shelf 112 and on a second end to the horizontal support beam 111. In one embodiment, the vertical center bar 113 is coupled to a substantially central point on the horizontal receiving shelf 112 and a substantially central point on the horizontal support beam 111. The horizontal support beam 111 and the horizontal receiving shelf 112 are substantially parallel with each other and substantially perpendicular to the vertical center bar 113. However, such relative positions of the vertical center bar 113, the horizontal receiving shelf 112, and the horizontal support beam 111 may be oriented differently in other embodiments of the present disclosure.

When resting on the ground, the fishing gear holding apparatus 110 is supported by two extendable legs 114. In this embodiment, the legs 114 are separate and may be individually actuated (rotated), but may be otherwise constructed in other embodiments. For example, the legs 114 may be connected by a horizontal support bar that couples to both legs 114.

A detachable hitch 115 is shown coupled to the vertical center bar 113. The detachable hitch 115 may be used while the fishing gear holding apparatus 110 in not being transported. However, during transport, the detachable hitch 115 may be coupled to the fishing gear holding apparatus 110 and used to couple the apparatus 110 to a hitch (not shown) of a vehicle. Removing the detachable hitch 115 while the apparatus 110 is in use, i.e., used to support fishing gear while a fisherman fishes, provides stability for the apparatus 110 during its use.

The embodiment of the frame 141 shown in FIG. 1 is exemplary and the size and general shape of any of the components may vary in different embodiments without changing the nature of the apparatus 110.

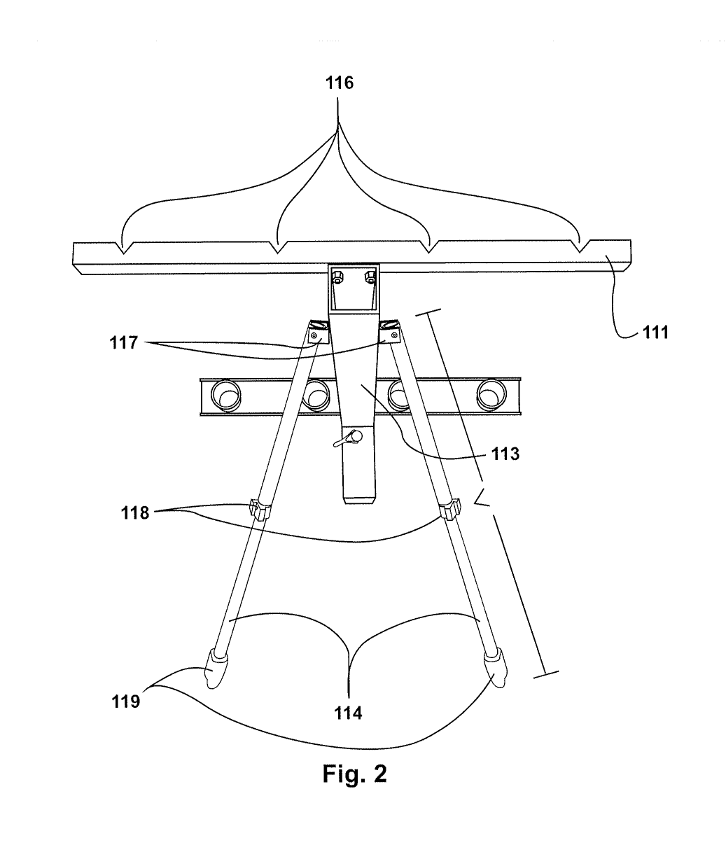

FIG. 2 depicts a top view of the apparatus 110 shown in its “in use” position, i.e., the legs 114 are extended, the frame 141 extends at an angle from the legs 114, and the apparatus 110 rests in a standing position, as shown in FIG. 1.

Four V-shaped notches 116 are cut into the horizontal support beam 111. The notches 116 are configured and arranged to cradle and support fishing rods (not shown) when the apparatus 110 is in use, and may vary in both quantity, shape, and dimensions in other embodiments.

The two legs 114 are shown coupled to the vertical center bar 113 using rotating brackets 117. Note that the legs 114 are constructed to be set in an “actuated” or “not actuated” position. In the not actuated position, the legs 114 are fully retracted and rest adjacent and substantially parallel to the vertical center bar 113. When the legs 114 are in such a position, the apparatus is easier to store and transport.

In the actuated position, the legs 114 are rotated and extended such that the frame 141 may rest comfortably on the ground for fishing use. The legs 114 are also constructed to be set at a variable height using extendable locking devices 118 to adjust the length L. The adjustable length L of the legs 114 and the rotating brackets 117 allow for the apparatus 110 to be placed on a variety of terrain with stability and increased functionality. The tips of the legs 114 opposite the rotating brackets 117 are capped with protective feet 119 for added support when placed on challenging terrain.

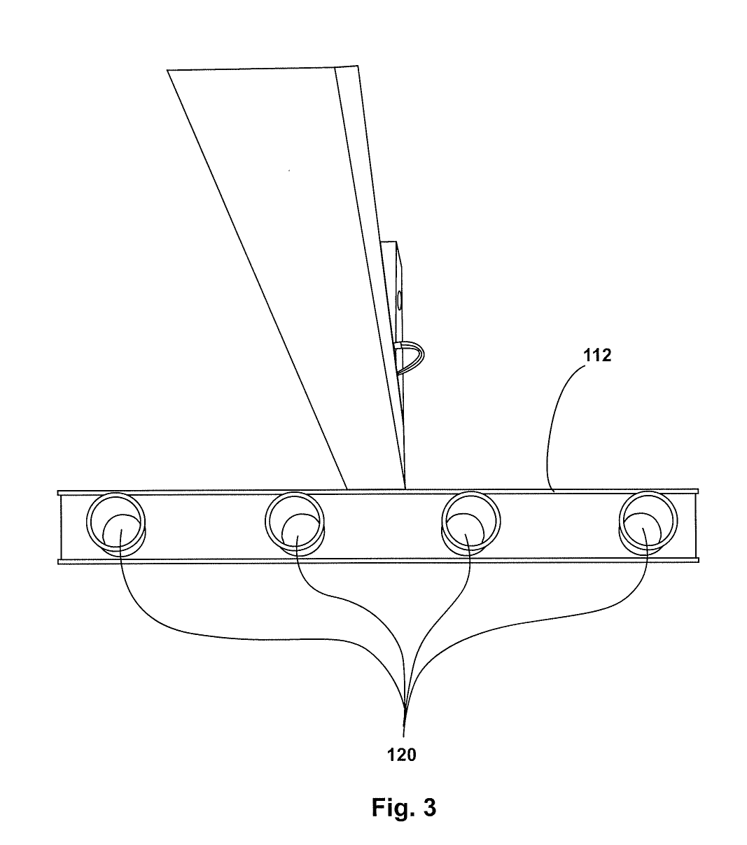

FIG. 3 depicts a top view of the horizontal receiving shelf 112 extending from the bottom of the vertical center bar 113. Cylindrical cups 120 extend from the top side of the horizontal receiving shelf 112 set at roughly equidistant intervals along the receiving shelf 112. There are four cups 120 shown in FIG. 3; however, additional or fewer cups 120 are possible in other embodiments. Further, the cups 120 are shown as cylindrical; however, other shapes of cups are possible in other embodiments of the present disclosure.

In one embodiment, the cups 120 are configured and arranged to receive, cradle, and support handles of fishing rods (not shown) when in use on the ground or during transportation using a vehicle (not shown).

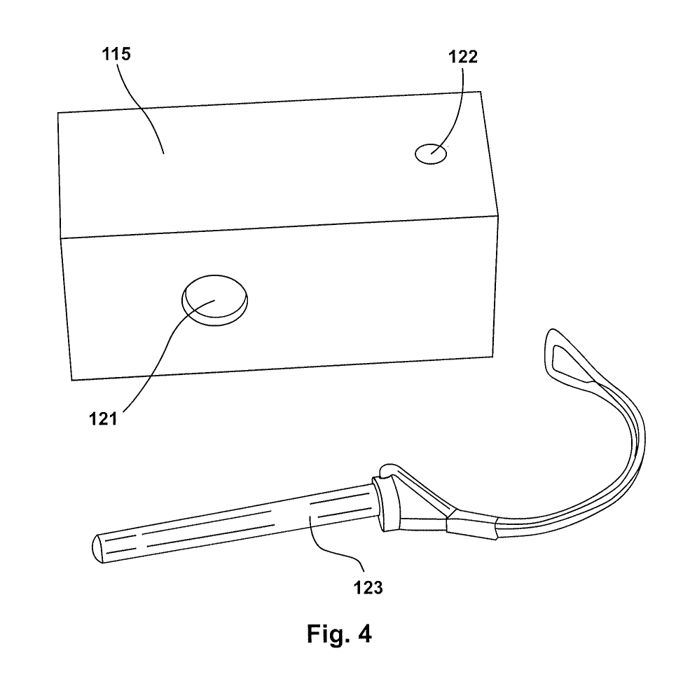

FIG. 4 depicts the detachable hitch 115 used to couple the apparatus 110 (FIG. 1) to a vehicle (not shown) for transportation. In this particular embodiment, the hitch 115 is detachable from the apparatus 110, but in other embodiments the hitch 115 may be fixedly coupled and secured to the vertical center bar 114 (FIG. 1). The hitch 115 consists of a hollow cube structure with a hole 121 passing through opposing walls of the cube for attaching to a standard trailer hitch of a motor vehicle (not shown). On the opposite end of the hitch 115 a second smaller hole 122 is located through opposing walls of the cube perpendicular to hole 121. The hole 122 is used to attach the hitch 115 to the apparatus 110. A large pin 123 is placed through the holes 122 to firmly couple the hitch 115 to the apparatus 110.

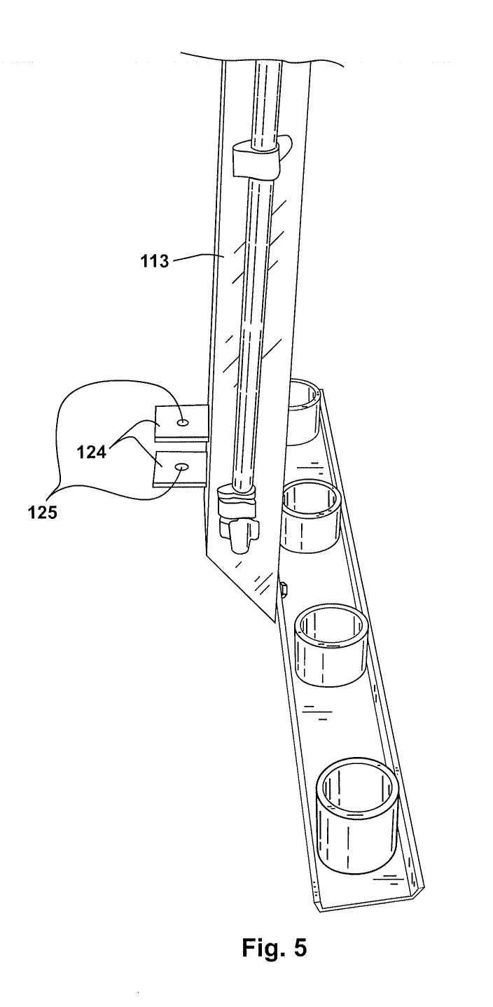

FIG. 5 depicts a side view of the lower portion of the vertical center bar 113. Two small rectangular plates 124 extend from the back side of the vertical center bar 113. Each of the plates has a small opening 125 approximately the same size as the hole 122 in the hitch 115 (FIG. 4). The hitch 115 is designed to slide snugly over the plates 124, such that the openings 122 of the hitch 115 align with the openings 125 in the plates 124. A pin (not shown) may then be inserted through the openings 122 and 125 to secure the hitch 115 to the apparatus 110.

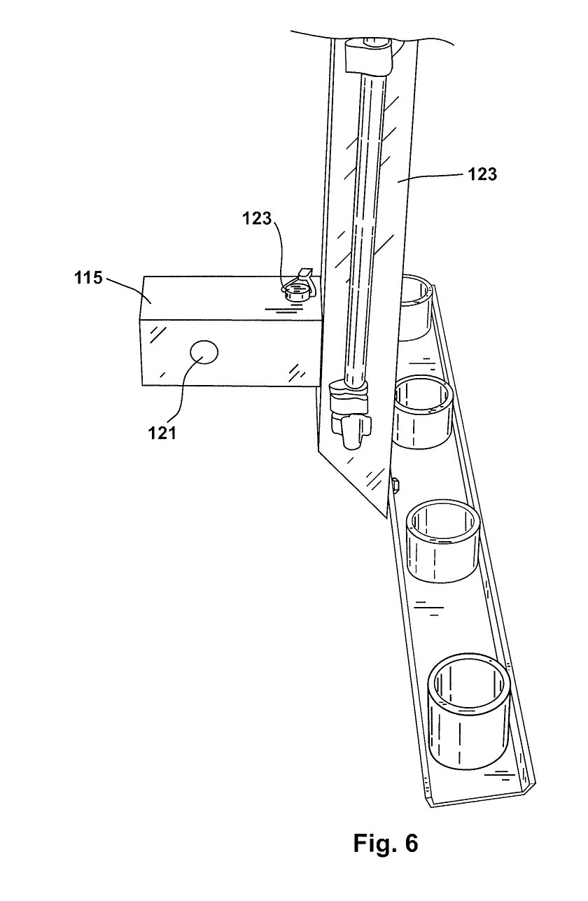

FIG. 6 depicts a side view of the lower portion of the vertical center bar 113 with the hitch 115 coupled to the apparatus 110. The hitch 115 fits snugly around the two plates 124 with the pin 123 passing through the openings 122 (FIG. 4) in the hitch 115 and the openings 125 (FIG. 5) in the plates 124. The pin 123 serves as a locking mechanism to keep the hitch 115 firmly secured to the vertical center bar 113.

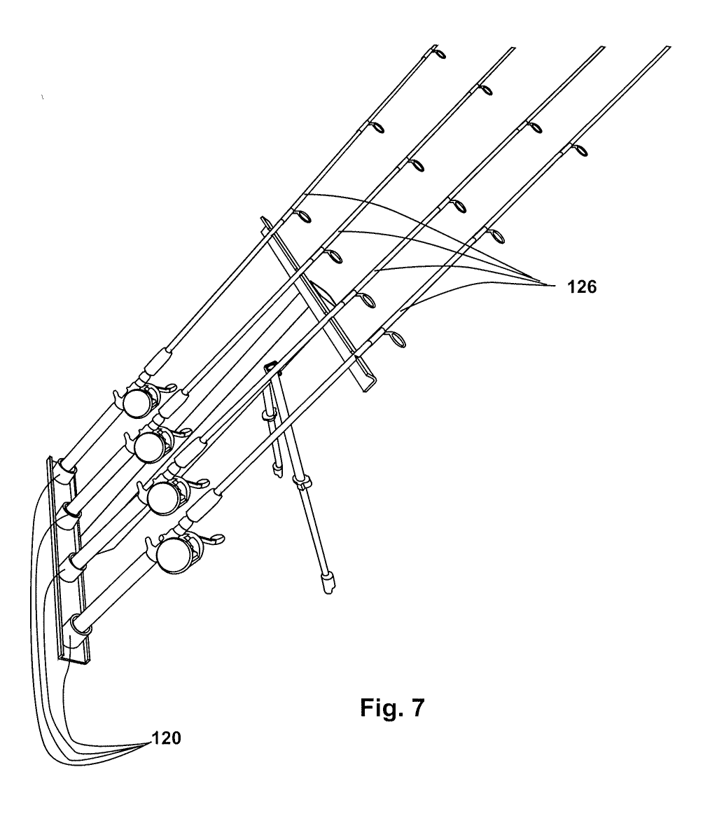

FIG. 7 depicts a side view of the apparatus 110 in position for its use as a fishing rod 126 holder. The apparatus 110 may be placed on the ground next to a body of water, with the fishing rods 126 secured in the apparatus 110 while attempting to catch fish. In use, the fisherman (not shown) may “cast” the lines from the fishing rods 126 into the body of water next to the apparatus 110. After casting, the fisherman (not shown) may place the handles of the fishing rods 126 securely into the cups 120 of the horizontal receiving shelf 112. The fishing rods 126 may then be monitored by the fisherman (not shown) for fish hooked on the lines.

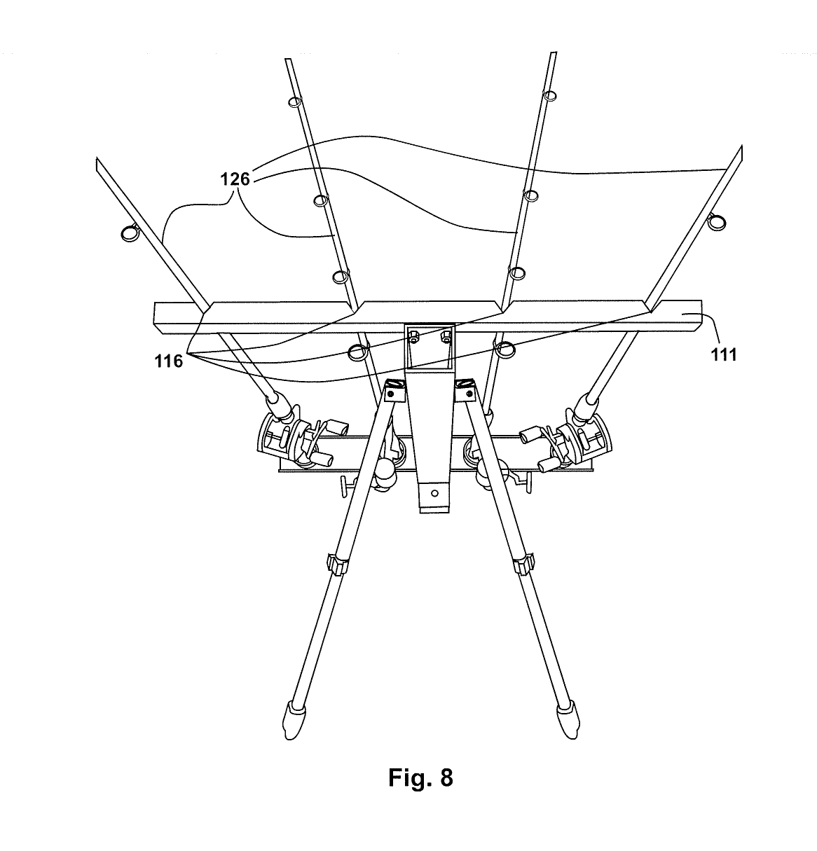

FIG. 8 depicts a top view of the apparatus 110 in the same position for use as a fishing rod holder. From this view, the top of the rods 126 can be seen resting in the V-shaped notches 116 of the horizontal support beam 111 in order to stop the rods 126 from sliding around when in use. The rods 126 are not otherwise secured to the apparatus 110 to allow the user (not shown) easy access to them in the event of a “catch” and for recasting purposes.

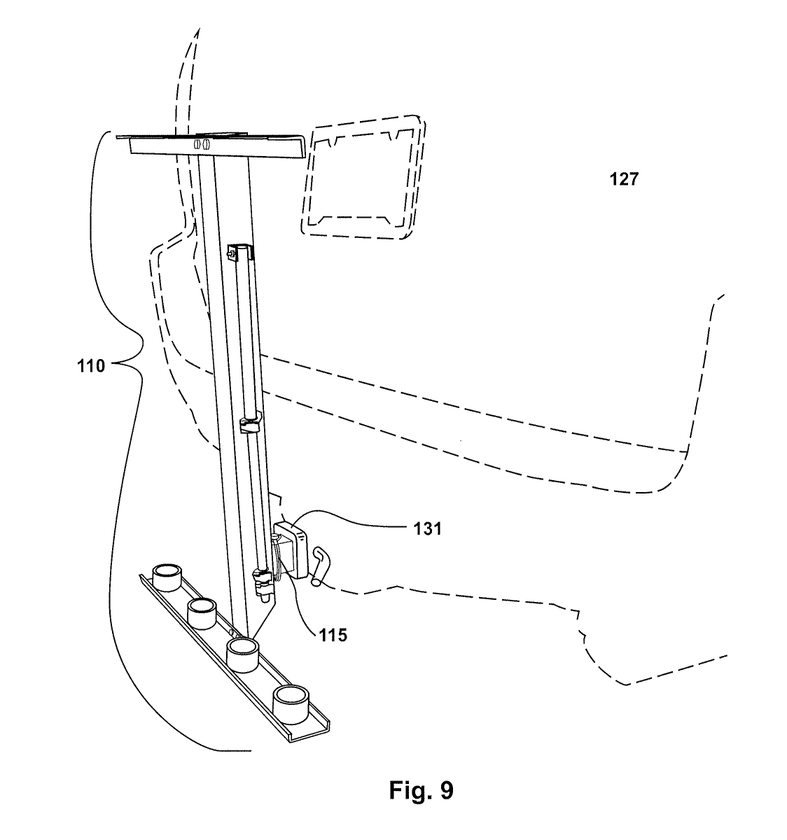

FIG. 9 depicts the apparatus 110 attached to a vehicle 127 for use in transportation of the fishing rods 126. The apparatus 110 is secured to the vehicle 127 using the hitch 115, which is attached to the standard trailer hitch receiver 131 using a standard trailer hitch pin 128 placed through the holes 121 in the hitch 115. To prevent them swinging while the vehicle is in motion, the legs 114 may be secured using a coupling device 129 such as an elastic cord (shown in this embodiment).

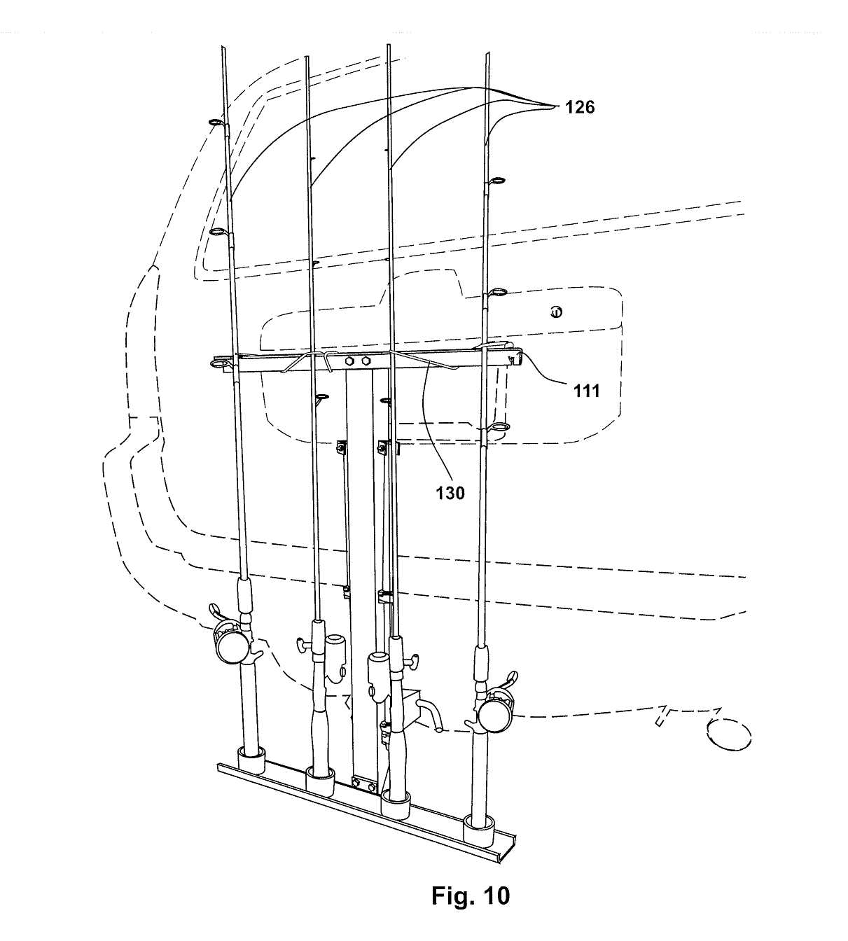

FIG. 10 depicts the apparatus 110 attached to a vehicle 127 fully loaded with fishing rods 126. In this manner, the apparatus 110 is in use for the safe and easy transportation of the fishing rods 126. The handles of the rods 126 are secured in the cups 120 located along the horizontal receiving shelf 112. The rods 126 are secured along the horizontal support beam 111 using a coupling device 130 such as an elastic cord (shown in this embodiment).

As described above and shown in the associated drawings, the present disclosure comprises a fishing gear holding apparatus. While particular embodiments have been described, it will be understood, however, that any embodiment appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the disclosure.

What is claimed is:

1. An apparatus, comprising:
a frame comprising a receiving shelf and horizontal support beam respectively coupled to opposing ends of a vertical center beam;
at least one leg coupled to the frame arranged and positioned such that when the leg is actuated the frame stands upright and a fishing rod may be supported by the receiving shelf and the horizontal support beam; and
a hitch coupled to the frame arranged and positioned such that when the at least one leg is not actuated, the frame may be coupled to a vehicle.

2. The apparatus of claim 1, wherein the frame is substantially I-shaped.

3. The apparatus of claim 1, wherein the legs are extendable.

4. The apparatus of claim 1, wherein the legs are rotatable.

5. The apparatus of claim 1, wherein the hitch is removeable.

6. The apparatus of claim 1, wherein the frame is coupled to a vehicle by inserting the hitch in a hitch receiver.

7. The apparatus of claim 1, wherein the frame is angled such that a rod may be supported by the apparatus when the legs are actuated.

8. The apparatus of claim 1, wherein the receiving shelf comprises small cups for holding fishing rods.

9. A method, comprising:
providing a frame comprising a receiving shelf and horizontal support beam respectively (independently) coupled to opposing ends of a vertical center beam;
providing at least one leg coupled to the frame arranged such that when the leg is actuated the frame stands upright and a fishing rod may be supported by the receiving shelf and the horizontal support beam; and
providing a hitch coupled to the frame arranged and positioned such that when the at least one leg is not actuated, the frame may be coupled to a hitch receiver; and
inserting at least one fishing rod into the receiving shelf and resting the fishing rod on the support beam.
